(19) United States
(12) Patent Application Publication
(10) Pub. No.: US 2005/0125267 A1
(43) Pub. Date: Jun. 9, 2005

(54) Method and system for re-accommodating passengers

(75) Inventors: Arnold H. Bramnick, Boca Raton, FL (US); J. Kendall Burch, Cooper City, FL (US); Lee E. Farnum, Fairfield, CT (US)

Correspondence Address: Gregory A. Nelson;Akerman Senterfitt, Fourth Floor, P.O. Box 3188, West Palm Beach, FL, 33402-3188, US

(73) Assignee: International Business Machines Corporation, Armonk, NY (US)

(21) Appl. No.: 10/731,233

(22) Filed: Dec. 9, 2003

(51) Int. Cl. G06F 17/60

(52) U.S. Cl. 705/5

(57) ABSTRACT

A method for re-accommodating passengers can include the step of obtaining passenger data for the passengers. The passenger data can be displayed to an airline employee and used to select passengers for re-accommodation. A set of rules can be applied to make the selection of passengers for re-accommodation.

### BACKGROUND

1. Field of the Invention

This invention relates generally to the commercial airline industry and, more particularly, to systems and methods for re-accommodating passengers who are unable to travel on scheduled flights.

2. Description of the Related Art

Passengers are sometimes unable to travel on scheduled flights for a variety of reasons. Frequently the passenger is scheduled to make a connecting flight and the passenger's inbound flight is delayed. Other times the originating or connecting flight is canceled because of mechanical problems, crew availability, weather conditions, or other factors. When such flights are missed, passengers must be rescheduled on other flights.

Currently, such rescheduling decisions are based only on the availability of seats on alternative flights. In the event that the only suitable alternative flights available are those of another airline, the original airline pays a pre-agreed price for the seat. The re-routing fee is sometimes more than the unflown ticket value. The airline then loses money on the connection.

Also, passengers who have proved loyal to the airline through frequent flyer status or the purchase of more expensive fares are treated the same as other passengers who must be re-routed. This can decrease passenger loyalty in the future.

### SUMMARY OF THE INVENTION

A method for re-accommodating passengers who are unable to travel on scheduled flights can include the step of obtaining passenger data and flight operations data. At least the passenger data is presented to an airline employee for use in selecting passengers for re-accommodation.

The passenger data can include the frequent flyer status of the passenger. The remaining flight ticket value of each passenger can be considered. The rebooking costs for each passenger can be considered, such as payments that may be required to another airline and the cost of meal and hotel reimbursements. The lifetime value for each passenger can be included in the passenger data. The passenger data can also include re-accommodation data. Re-accommodation data can specify whether another flight on the same airline is available or whether the passenger must be re-accommodated on a competitor airline.

A system for re-accommodating passengers can include means for obtaining passenger data and flight operations data. A display is provided for at least the passenger data for use in selecting passengers for re-accommodation.

### BRIEF DESCRIPTION OF THE DRAWINGS

There are shown in the drawings embodiments which are presently preferred, it being understood, however, that the invention is not limited to the precise arrangements and instrumentalities shown:

FIG. 1 is a schematic diagram of a system according to one embodiment of the invention.

FIG. 2 is an illustration of a screen shot according to one aspect of the invention.

FIG. 3 is an illustration of a screen shot according to another aspect of the invention.

FIG. 4 is a flow diagram illustrating a method according to another embodiment of the invention.

### DETAILED DESCRIPTION OF THE PREFERRED EMBODIMENTS

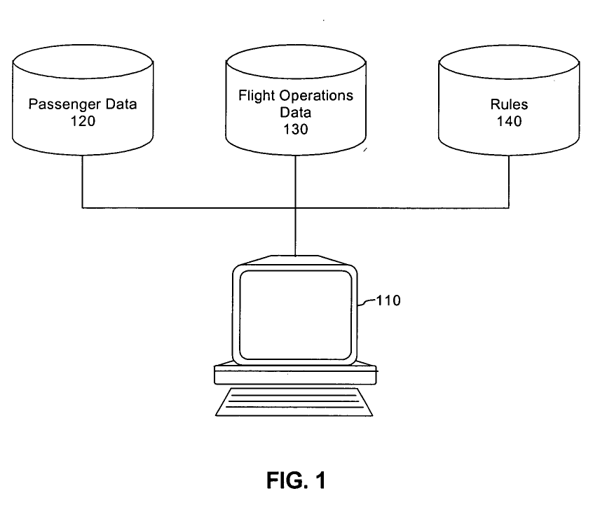

There is shown in FIG. 1 a system for re-accommodating passengers in accordance with one embodiment of the invention. The system 100 includes an information processing system 110, passenger data 120, flight operations data 130, as well as rules 140. The information processing system 110 can access the passenger data 120, flight operations data 130, as well as rules 140. For example, the passenger data 120, the flight operations data 130, and the rules 140 each can be included within a suitable data store. Each data store can be linked with the information processing system 110 via suitable communications links.

In one embodiment of the present invention, the information processing system 110 can be a client system configured to access a server. The server can be configured to perform one or more of the functions described herein. For example, the information processing system 110 can be implemented as a dumb terminal. In another embodiment, the information processing system 110 can include processing capability. For instance, the information processing system 110 can be a conventional computer system configured to perform one or more of the functions disclosed herein, with or without the cooperation of a server.

The passenger data 120 can include any suitable passenger data, including, but not limited to passenger financial data. The passenger data 120 can include the frequent flyer status of the passenger as the airline may wish to accommodate a frequent flyer. The passenger data 120 can also include the remaining unflown ticket value for each passenger. A passenger having a higher remaining ticket value may be re-accommodated, particularly if the failure to do so would require a less financially optimal flight for the airline or if the passenger must be re-accommodated on another airline. The rebooking cost for each passenger can be considered. The rebooking cost can include payments to other airlines if a passenger must travel on another airline, or the value of meals and hotel charges if rebooking of the passenger will involve an extended stay. The lifetime value of the passenger can also be considered. The airline may wish to accommodate a passenger if the passenger has a history of purchasing profitable tickets for the airline, such as business class tickets. The passenger data 120 can also include re-accommodation data which includes the availability of flights of the same airline, or whether the passenger must be re-accommodated on a competitor airline. The passenger data 120 can also include customer relationship management (CRM) data or other suitable data.

The flight operations data 130 can be any suitable flight operations data. The flight operations data 130 can include flight schedule and seat availability on the airline and competitor airlines for rebooking flight candidates. Although the flight operations data 130 and the passenger data 120 are shown as being located in separate data stores, the data can be combined into a single data store or provided in a plurality of data stores. Further, the flight operations data 130, the passenger data 120, and the rules 140 can be stored within the information processing system 110 or can be remotely located from the information processing system 110.

An example of the operation of the invention concerns a flight 123 which is late on arrival by 45 minutes, causing 20 passengers to miss connections. The airline only has enough seats to re-accommodate 12 of the passengers on its own. The airline employee must determine which 8 passengers must be re-accommodated on other airlines. According to present methods, the airline employee would randomly select the first 12 passengers for re-accommodation, perhaps on a first come first serve basis, and the last 8 passengers would be required to travel on another airline. According to the invention, the airline employee would be presented with an integrated display of passenger data for all passengers requiring re-accommodation and flight operations data which can include rebooking flight candidates.

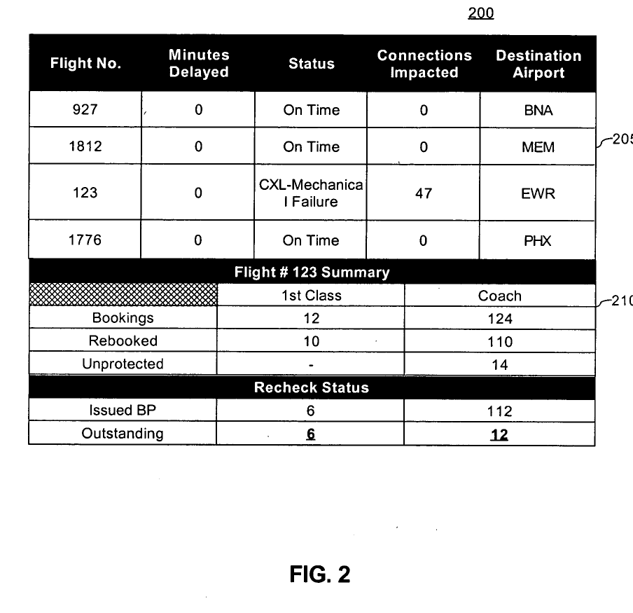

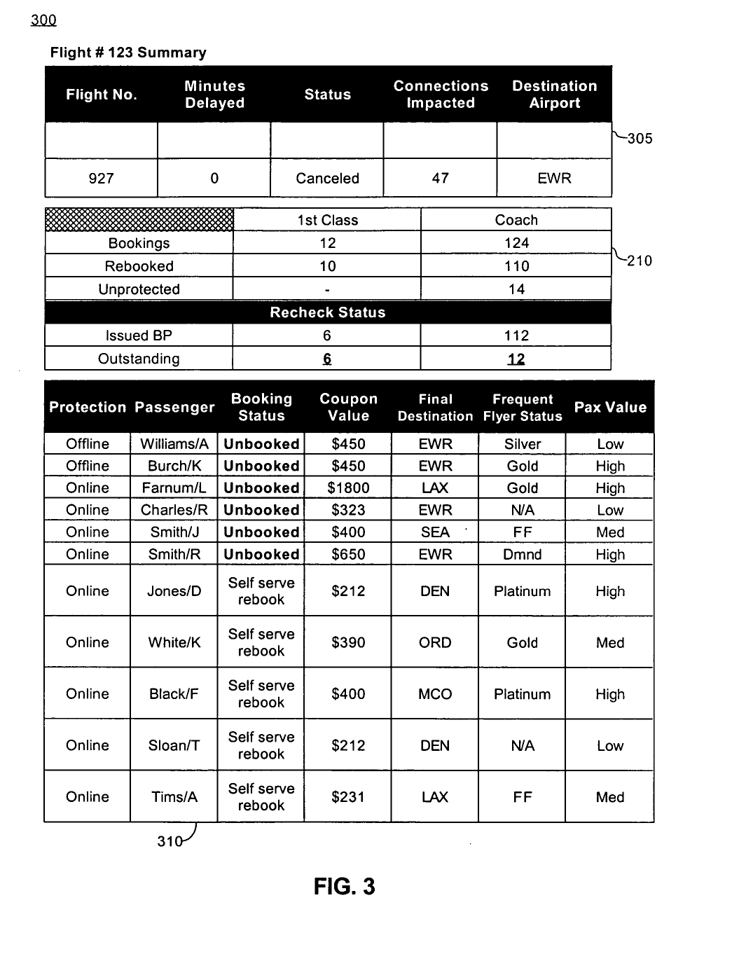

There is shown in FIG. 2 a graphical user interface (GUI) 200 with a section 205 indicating the affected flights resulting in the need for re-accommodating passengers. The GUI 200 can include a section 210 indicating the number of passengers who have been successfully re-accommodated and the remaining passengers, in this case, 6 in first class and 12 in coach, who are unprotected, meaning that they remain to be re-accommodated. A subsequent screen 300, shown in FIG. 3, provides a section 305 with details on canceled flight 123, as well as a section 310 with details on the remaining unbooked passengers. The section 310 includes an indication of the remaining unflown coupon value for each passenger, the final destination, the frequent flyer status, and the passenger value (PAX) as determined by the CRM system. The airline employee is then able to make a decision as to which passengers should be re-accommodated on the airline, and which passengers should be re-routed to other airlines.

It is also possible that rules can be applied to make a selection for the airline employee as to which passengers should be re-accommodated on the airline or on preferential flights, and which passengers should not. Rules 140 can be provided for selecting among the passengers. The rules 140 can be any suitable rules for selecting among passengers according to passenger data 120 and/or flight operations data 130. In one aspect, the rules can require the selection of passengers according to the descending revenue impact on the airline. In another aspect, the rules can require selection based on the lifetime value of the passenger, which can be a valuation based upon factors such as frequent flyer status and passenger travel history. In another aspect, the rules can weigh various passenger data according to the preferences of the airline and select those passengers with the most favorable scores. Each of the aforementioned attributes, and combinations thereof, can be considered. Further, it should be appreciated that the rules can specify how raw data can be processed to determine one or more of the aforementioned valuation methods if such information is not directly available from one of the data stores.

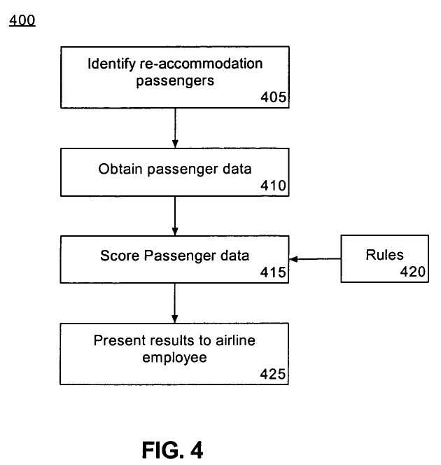

A method 400 is shown in FIG. 4. The method begins with the identification of passengers who must be re-accommodated in step 405. Passenger data is obtained in step 410 for the passengers to be re-accommodated. The passenger data can be scored in a step 415 according to rules 420. As noted, the rules can take into account passenger data and/or flight operation data. The results are presented to the airline employee in step 430.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suitable. A typical combination of hardware and software can be a general purpose computer system with a computer program that, when being loaded and executed, controls the computer system such that it carries out the methods described herein.

The present invention can also be embedded in a computer program product, which includes all the features enabling the implementation of the methods described herein, and which when loaded in a computer system is able to carry out the methods. Computer program in the present context means any expression, in any language, code or notation of a set of instructions intended to cause a system having an information processing capability to perform a particular function either directly or after either or both of the following: (a) conversion to another language, code or notation; or (b) reproduction in a different material form.

This invention can be embodied in other forms without departing from the spirit or essential attributes thereof and, accordingly, reference should be had to the following Claims rather than the foregoing specification as indicating the scope of the invention.

1. A method for re-accommodating passengers who are unable to travel on scheduled flights, comprising the steps of:
obtaining passenger data for said passenger;
presenting said passenger data to an airline employee; and
selecting passengers for re-accommodation based upon said presenting step.

2. The method of claim 1, further comprising the step of displaying flight operations data in said presenting step.

3. The method of claim 1, wherein said passenger data comprises the frequent flyer status of the passenger.

4. The method of claim 1, wherein said passenger data comprises the remaining unflown ticket value of each passenger.

5. The method of claim 1, wherein said passenger data comprises the rebooking cost of each passenger.

6. The method of claim 1, wherein said passenger data comprises passenger lifetime value data.

7. The method of claim 1, wherein said passenger data comprises re-accommodation data.

8. The method of claim 1, further comprising the step of applying a set of rules to score said passengers, and displaying this score in said display.

9. The method of claim 8, wherein said rules comprise arranging said passengers according to a descending revenue impact to the airline.

10. The method of claim 8, wherein said rules comprise arranging said passengers according to passenger frequent flyer status.

11. The method of claim 8, wherein said rules require arranging said passengers according to passenger lifetime value data.

12. A system for re-accommodating passengers, comprising:
means for storing passenger data; and
means for displaying said passenger data for re-accommodation candidates and for selecting passengers for re-accommodation based upon said display.

13. A machine-readable storage having stored thereon a computer program having a plurality of code sections executable by a machine for causing the machine to perform the steps of:
obtaining passenger data for said passenger;
presenting said passenger data to an airline employee; and
selecting passengers for re-accommodation based upon said presenting step.

14. The machine-readable storage of claim 13, further comprising the step of displaying flight operations data in said presenting step.

15. The machine-readable storage of claim 13, wherein said passenger data comprises the frequent flyer status of the passenger.

16. The machine-readable storage of claim 13, wherein said passenger data comprises the remaining unflown ticket value of each passenger.

17. The machine-readable storage of claim 13, wherein said passenger data comprises the rebooking cost of each passenger.

18. The machine-readable storage of claim 13, wherein said passenger data comprises passenger lifetime value data.

19. The machine-readable storage of claim 13, wherein said passenger data comprises re-accommodation data.

20. The machine-readable storage of claim 13, further comprising the step of applying a set of rules to score said passengers, and displaying this score in said display.

21. The machine-readable storage of claim 20, wherein said rules comprise arranging said passengers according to a descending revenue impact to the airline.

22. The machine-readable storage of claim 20, wherein said rules comprise arranging said passengers according to passenger frequent flyer status.

23. The machine-readable storage of claim 20, wherein said rules require arranging said passengers according to passenger lifetime value data.
